(19) United States
(12) Patent Application Publication
(10) Pub. No.: US 2006/0231334 A1
(43) Pub. Date: Oct. 19, 2006

(54) Stepladder stabilizer

(76) Inventors: Bill R. Hall, Anaheim, CA (US); Stephen Burd, Anaheim, CA (US)

Correspondence Address: WALTER A. HACKLER, 2372 S.E. BRISTOL, SUITE B, NEWPORT BEACH, CA, 92660-0755, US

(21) Appl. No.: 11/109,251

(22) Filed: Apr. 18, 2005

(51) Int. Cl. E06C 1/00

(52) U.S. Cl. 182/172

(57) ABSTRACT

A stepladder stabilizer includes a set of four feet with each foot having a sole and an upstanding ankle. Each ankle is abuttable with a corresponding stepladder leg and each sole lies in a horizontal plane. Each ankle is affixed to a corresponding stepladder leg and further each ankle is disposed at a fixed ankle to a corresponding sole with the fixed ankle being equal to a leg ankle defined between a corresponding stepladder leg and the horizontal plane when the ladder legs are in a fully spread position.

The present invention generally relates to ladder stabilizing devices and is more particularly directed to a stepladder stabilizer. The use of stepladder stabilizing devices has long been known. Typically, pivotally mounted shoe members have been installed on the feet of stepladders for the purpose of preventing tipping of the ladder and to enable the stepladder to conform to varying terrains of changing contour and density.

In addition, stabilizing devices have included support members extending from the stepladder to operate as an outriggers. This, however, obviously creates an objectionable safety hazard, particularly in cramped areas. In addition, such devices seldom improve the stability of a stepladder on soft areas into which the stepladder legs may non-uniformly sink.

The present invention is directed to a stepladder stabilizer which provides for improved stability of a conventional folding stepladder on not only hard but soft areas into which the stepladder legs may non-uniformly sink. In addition, the present invention provides for lateral stability of the stepladder to compensate for a user shifting the center of gravity, of the combined stepladder and user, to unsafe conditions.

The present invention provides these features while at the same time enabling the stepladder to be folded and stored in a conventional manner.

### SUMMARY OF THE INVENTION

A stepladder stabilizer in accordance with the present invention generally includes a set of four feet with each foot having a sole and upstanding ankle. Each ankle is abuttable with a corresponding stepladder leg with each sole lying in a generally horizontal plane. Means are provided for fixing each abutting ankle to a corresponding stepladder leg.

More particularly, each ankle may have a width approximately equal to the corresponding leg to enable folding of the stepladder with abutting stepladder legs in a manner unhindered by the attachment of the feet to the stepladder legs.

Still more particularly, each ankle may be disposed at a fixed angle to a corresponding sole with the fixed angle being equal to a leg angle defined between the corresponding stepladder leg and a horizontal plane with the stepladder legs and in a fully spread position.

The means for fixing each ankle to the corresponding stepladder leg preferably comprises a tie although screws or the like be employed depending upon the permanency of attachment desired.

Each sole may include a heel extending from a corresponding ankle with each heel including a corresponding stepladder leg bottom supporting surface. In that regard, each sole and corresponding heel are disposed transverse to a plane common to a corresponding ankle and corresponding stepladder leg.

To enhance slipping resistance, a set of four socks may be provided with each sock fitting over a corresponding sole. In this embodiment, the foot is preferably molded from a resin and each sock is formed from a plastic softer than the resin. Such socks are removable and each sock surrounds a corresponding heel and overlaps a toe portion of a corresponding foot.

### BRIEF DESCRIPTION OF THE DRAWINGS

The advantages and features of the present invention will be better understood by the following description when considered in conjunction of the accompanying drawings, in which:

FIG. 1 is a perspective view of a stepladder with extended legs showing a stepladder stabilizer in accordance with the present invention generally including a set of four feet with each foot being attached to a corresponding stepladder leg;

FIG. 2 is an enlarged perspective view of one of the four feet in accordance with the present invention taken along the line 2-2 of FIG. 1 and generally showing an upstanding ankle, a sole, a heel, and a toe portion, along with a sock covering the toe portion and the heels;

FIG. 3 is an enlarged side view of a foot in accordance with the present invention attached to a corresponding leg and showing the ties for fixing the foot to the leg along with the angular relationship;

FIG. 4 is a plan view of a sole of the present invention covered with the sock; and

FIG. 5 is s side view of the stepladder shown in FIG. 1 illustrated in a closed position with such closure being unhindered by the attachment of the feet to corresponding stepladder legs.

### DETAILED DESCRIPTION

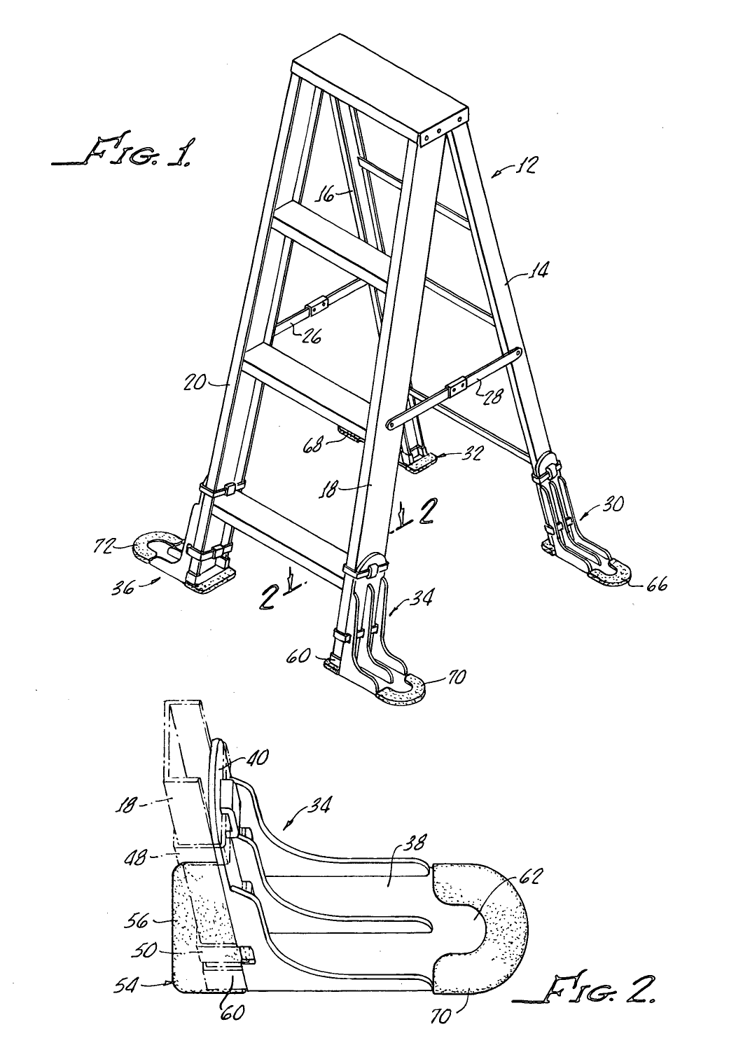

With reference to FIG. 1, there is shown a stepladder stabilizer 10 in accordance with the present invention installed on a stepladder 12 having fore legs 14, 16, and hind legs 18, 20, shown with the ladder legs 14, 16, 18, 20 in a fully spread position defined by foldable stringers 26, 28 in a conventional manner.

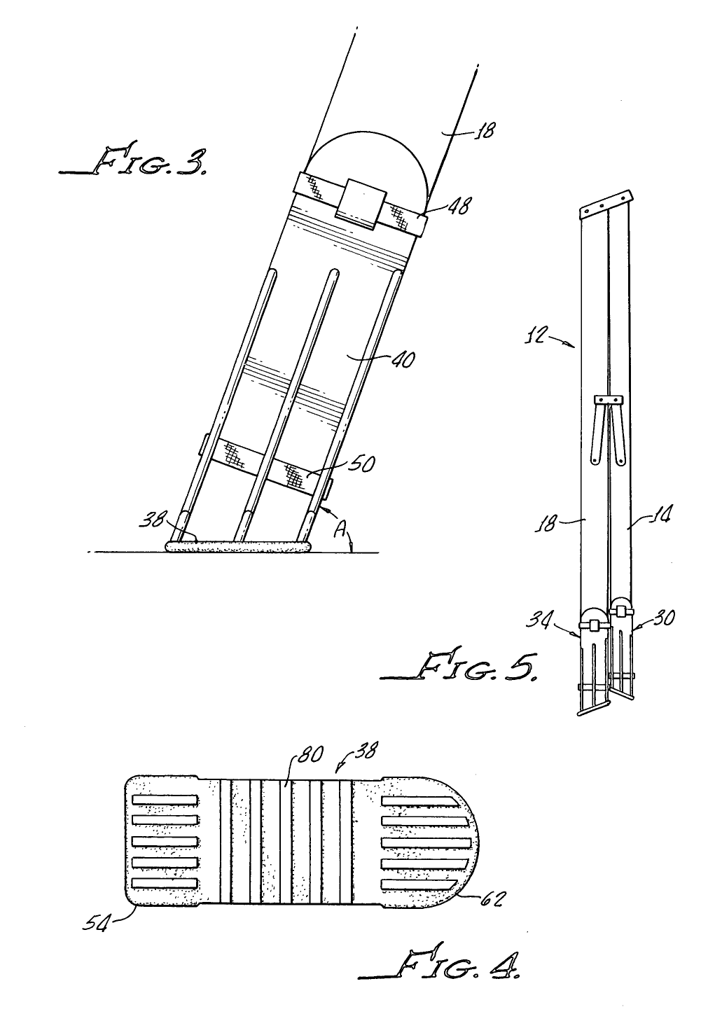

With reference also to FIGS. 2 and 3, the stabilizer 10 includes four feet 30, 32, 34, 36.

With particular reference to FIG. 2, the foot 34 will be described hereinafter in detail with such description being applicable to all of the feet 30, 32, 34, 36 with reference characters only provided for the foot 34 for the sake of brevity and clarity.

The foot 34 includes a sole 38 and an upstanding ankle 40 with the ankle 40 being abuttable with the corresponding stepladder leg 18 with the sole 38 lying in a horizontal plane 44, see FIG. 3. Conventional ties 48, 50, as shown, may be utilized and provide a means for affixing the abutting ankle 40 the corresponding stepladder leg 18.

As best illustrated in FIG. 3, the ankle 40 is disposed at a fixed angle “A” to a corresponding sole 38 with the fixed angle being defined between the corresponding stepladder leg 18 and the horizontal plane 44 with the ladder legs in a fully spread position, as shown in FIG. 1.

Because the angle and size of the stepladder legs 14, 16, 18, 20 are different, each of the feet 30, 32, 34, 36 are correspondingly unique from one another. However, the stabilizer 10 with the four feet 30, 32, 34, 36 will fit on any height stepladder for example, between a three-foot stepladder and a sixteen-foot stepladder.

With reference again to FIG. 2, the sole 38 includes a heel 54 which includes a surface 56 for supporting a stepladder leg bottom 60. Thus, the sole 38 which further includes a toe 62 is disposed transverse to a plane common to the ankle 40 and stepladder leg 18.

The increased surface area provided by the sole 38 provides greater stability to the ladder 12 and further reduces sinking of the stepladder leg 18 into soft soil (not shown).

For strength, the feet 30, 32, 34, 36 may be formed from, for example, and not being limited thereto, a glass filled resin to provide durability and strength.

In order to minimize slippage, four socks, 66, 68, 70, 72 may be provided.

By way of specific illustration as shown in FIG. 2, the sock 70 may be removably installed over the sole 38 including the toe 62 and heel 54 and may be preferably formed from a plastic softer than the resin. The sock 70 may include a tread pattern 80, as shown in FIG. 4, to minimize slippage.

Since the socks 66, 68, 70, 72 are pliable, they also prevent scratching when used on sensitive surfaces such as fine wood floors and the like and are removable to enable cleaning thereof, if necessary, as for example, indoor use of the ladder follows immediately after outdoor use.

While the stabilizer 10 with individual feet 30, 32, 34, 36 provide stability to the ladder 12 as well as limit sinking of legs 14, 16, 18, 20, and provide reduced slippage, the feet 30, 32, 34, 36 do not interfere with collapse of the ladder 12, as shown in FIG. 5.

This feature is enabled by the fact that the sole 38 is transverse to the leg 18 and further the ankle 40 has a width approximately equal to the stepladder leg 18 width.

Although there has been hereinabove described a specific stepladder stabilizer in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element which is not specifically disclosed herein. Accordingly, any and all modifications, variations or equivalent arrangements which may occur to those skilled in the art, should be considered to be within the scope of the present invention as defined in the appended claims.

What is claimed is:

1. A stepladder stabilizer comprising:
a set of four feet, each foot having a sole and an upstanding ankle, each ankle being abuttable with a corresponding stepladder leg with each sole lying in a horizontal plane; and
means for fixing each abutting ankle to the corresponding stepladder leg.

2. The stabilizer according to claim 1 wherein each ankle is disposed at a fixed angle to a corresponding sole, said fixed angle being equal to a leg angle defined between the corresponding stepladder leg and the horizontal plane with the ladder legs in a fully spread position.

3. The stabilizer according to claim 1 wherein the means for fixing each ankle to the corresponding stepladder leg comprises a tie.

4. The stabilizer according to claim 1 wherein each ankle has a width approximately equal to the corresponding leg to enable folding of the stepladder with abutting stepladder legs.

5. The stabilizer according to claim 1 wherein each sole includes a heel extending from a corresponding ankle, each heel including a corresponding stepladder leg bottom supporting surface.

6. The stabilizer according to claim 5 wherein each sole and corresponding heel are disposed transverse to a plane common to a corresponding ankle and corresponding stepladder leg.

7. The stabilizer according to claim 1 further comprising a set of four socks, each sock fitting over a corresponding sole.

8. The stabilizer according to claim 1 wherein each sole includes a heel extending from a corresponding ankle and the stabilizer further comprises a set of four socks, each sock fitting over a corresponding sole and heel.

9. The stabilizer according to claim 7 where each foot is molded from a resin and each sock is formed from a plastic softer than said resin.

10. The stabilizer according to claim 9 wherein each sock is removable from the corresponding sole.

11. The stabilizer according to claim 8 wherein each sock surrounds a corresponding heel and overlaps a sole portion of a corresponding foot.

12. A stepladder stabilizer comprising:
a set of four feet, each foot having a sole and an upstanding ankle, each ankle being abuttable with a corresponding stepladder leg with each sole lying in a horizontal plane, each ankle having a width approximately equal to a width of the corresponding leg.

13. The stabilizer according to claim 12 wherein each ankle is disposed at a fixed angle to a corresponding sole, said fixed angle being equal to a leg angle defined between the corresponding stepladder leg and the horizontal plane with the ladder legs in a fully spread position.

14. The stabilizer according to claim 12 wherein each sole includes a heel extending from a corresponding ankle, each heel including a corresponding stepladder leg bottom supporting surface.

15. The stabilizer according to claim 14 wherein each sole and corresponding heel are disposed transverse to a plane common to a corresponding ankle and corresponding stepladder leg abutting supporting surface.

16. The stabilizer according to claim 14 further comprising a set of four socks, each sock fitting over a corresponding sole.

17. The stabilizer according to claim 16 wherein each foot is molded from a resin and each sock is formed form a plastic softer than said resin.

18. The stabilizer according to claim 17 wherein each sock surrounds a corresponding heel and overlaps a toe portion of a corresponding foot.

19. The stabilizer according to claim 17 wherein each sock is removable from the corresponding sole and heel.

20. The stabilizer according to claim 19 further comprises ties removably fixing each ankle to the corresponding leg.
